(19) United States
(12) Patent Application Publication
(10) Pub. No.: US 2016/0369824 A1
(43) Pub. Date: Dec. 22, 2016

(54) TANDEM MASTER CYLINDER

(71) Applicant: Robert Bosch GmbH, Stuttgart (DE)

(72) Inventor: Masaki Shiwa, Paris (FR)

(21) Appl. No.: 15/187,325

(22) Filed: Jun. 20, 2016

(30) Foreign Application Priority Data
Jun. 22, 2015 (FR) 1555717

(51) Int. Cl. F15B 15/14

(52) U.S. Cl. CPC F15B 15/14

(57) ABSTRACT

Master cylinder having a housing with a borehole accommodating a primary piston controlled by the actuator extending beyond the borehole. The housing has a stoplight control having a drill hole whose axis is parallel to that of the borehole accommodating the piston, wherein the drill hole accommodates a magnet whose movement is coupled to that of the (primary) piston, and a Hall sensor outside the housing that detects the movement of the magnet to control the stoplights. The stoplight control comprises a moving assembly translationally integral with the primary piston at its extremity and comprising a bracket removably affixed to the extremity of the primary piston exiting the housing and a rod whose axis is parallel to the axis of the drill hole, connected to the bracket and whose extremity, engaged in the drill hole, bears a magnet to cooperate with the Hall Sensor.

### CROSS REFERENCE

The present application claims the benefit under 35 U.S.C. §119 of France Patent Application No. FR 1555717 filed on Jun. 22, 2015, which is expressly incorporated herein by reference in its entirety.

### FIELD

The present invention relates to a master cylinder having a housing equipped with a borehole accommodating a primary piston controlled by the actuator and extending beyond the borehole, the housing, equipped with a stoplight control having a drill hole whose axis is parallel to that of the borehole accommodating the piston (primary piston), wherein the drill hole accommodates a magnet whose movement is coupled to that of the piston (primary) and a Hall sensor outside the housing to detect the movement of the magnet in order to control the stoplights.

### BACKGROUND INFORMATION

A conventional tandem master cylinder may be equipped with a stoplight switch consisting of a magnet sliding in a drill hole of the housing of the master cylinder, whose axis is parallel to the master cylinder borehole in which the primary piston and the secondary piston slide. The magnet is pushed by a compression spring housed at the bottom of the drill hole and acting in the direction opposite that in which the master cylinder is actuated for braking.

The magnet is housed in a support affixed to the end of a rod that exits the drill hole and encounters a stop integral with the end of the primary piston as it projects beyond the master-cylinder borehole. The rod is guided in a sleeve forming a slide bearing affixed to the end of the drill hole.

A Hall sensor installed on the outside of the master-cylinder housing detects the position of the magnet at rest and controls the activation of the stoplights when the rod, pushed by the activated piston stop, leaves its rest position while compressing the return spring. The latter pushes the magnet into rest position whenever the thrust exerted by the primary piston of the master cylinder on the rod dissipates at the conclusion of braking.

A drawback of this master cylinder equipped with a stoplight switch is that it is relatively complicated with respect to both its structure and its operation. It is also affected by the accumulation of dirt in the drill hole in which the magnet slides. If the magnet gets stuck, the situation will be interpreted at the output as activation of the brake; the stoplights will remain permanently illuminated and no longer be capable of indicating a braking action to the driver following behind.

An additional drawback of this master cylinder is that not only is its structure fragile because of the stoplight switch, but also it is complex due to this switch.

An object of the present invention is to develop a brake booster equipped with a stoplight switch for braking whose construction is simple and provides safe and efficient operation.

### SUMMARY

An object of the present invention is a master cylinder, wherein the stoplight control comprises a moving assembly translationally integral with the end of the primary piston and having a bracket removably affixed to the end of the primary piston exiting the housing of the master cylinder and a rod whose axis is parallel to the axis of the drill hole, connected to the bracket, whose extremity, engaged in the drill hole, holds a magnet to cooperate with the Hall sensor.

A master cylinder in accordance with the present invention may have the advantage of being of especially simple realization due to the reduced number of parts in the stoplight switch, thereby ensuring proper operation and reliability when detecting brake actuation. Additionally, the system is simple to implement and, in the event of a fault, can be easily replaced because it is simply clipped to the primary piston in such a way that the entire assembly, together with the magnet, can be easily removed from the master cylinder for replacement.

According to another beneficial characteristic, the bracket is affixed to the rear of the primary piston exiting the master-cylinder housing by a connector that is free to rotate around the axis of the piston.

This realization simplifies assembly and operation because there is no risk of any thrust being transmitted by the possible pivoting, no matter how slight, of the master cylinder around its axis. This pivoting or rotational movement cannot induce thrust in the rod carrying the magnet and thereby cause the rod to deviate from the drill-hole axis.

According to another advantageous characteristic, the ring has a lateral foot to which is hooked the head of the rod aligned with the drill-hole axis that accommodates it. This lateral foot, although rigid in order to transmit the translational movement of the piston to the rod, simply constitutes a drive organ. Because, rearward, the ring is freely mounted in rotation with respect to the primary piston, this foot is not subject to any thrust from the ring and the tongues with their hook so that no thrust is applied to the rod carrying the magnet.

According to another advantageous characteristic, the hook section is in the shape of a rectangular triangle one of whose right-angle rear sides is perpendicular to the axis and its hypotenuse forms an incline descending toward the axis in the forward direction and the groove has a rectangular triangular section having a straight side perpendicular to the axis and a hypotenuse forming the front of the groove, the second side of the rectangular apex being the open side of the groove. This hook shape is very simple and advantageous for the installation of the bracket formed by the ring, which is engaged simply by pressing into the rear opening of the primary piston until the hooks catch in the interior peripheral groove of the triangular section forming a retention surface, which prevents extraction of the ring together with its tongues and enables the moving assembly to be pulled in the direction of actuation of the primary piston and, thus, of the tandem master cylinder during braking. The return to rest position occurs by the opposite movement of the master cylinder, which pushes the moving assembly and pulls the rod, along with its magnet, in the direction opposite the previous direction.

According to another advantageous characteristic, the rear of the primary-piston sleeve has a conical entrance, which facilitates the movement of compressing the tongues of the ring of the moving assembly without it being necessary to resort to an artifice to compress the tongues in order to reduce the contour of the crown of hooks for engagement in the rear of the primary-piston sleeve.

According to another advantageous characteristic, the bracket formed by the ring and the tongues equipped with hooks, as well as the foot and the rod bearing the magnet, are of plastic. This realization has the benefit of being simple to produce and implement. Moreover, the assembly added to the master cylinder is quite light in weight while having sufficient mechanical strength for its operation.

### BRIEF DESCRIPTION OF THE DRAWINGS

The present invention is described in greater detail below using the embodiments of the tandem master-cylinder shown in the figures.

FIG. 1 is a perspective view of a tandem master cylinder according to the present invention, whose pistons are shown as if the housing were transparent.

FIG. 2 is a perspective view of the primary piston and the moving assembly carried by the primary piston, shown without the housing.

FIG. 3 is a partial cutaway of the master cylinder showing the primary piston and, in part, the secondary piston.

FIG. 4 is an axial view of a variant of the rear of the primary piston and the hooking of the moving assembly.

### DETAILED DESCRIPTION OF EXAMPLE EMBODIMENTS

To facilitate the description, below, the front of the tandem master cylinder is referred to as AV and the rear as AR, corresponding to the position of the primary piston and the actuator that controls it, according to the customary arrangement of the elements of a master cylinder, not shown.

Although the following description applies to a tandem master cylinder, the present invention is not limited to such a master cylinder and applies, under the same conditions, to a simple master cylinder.

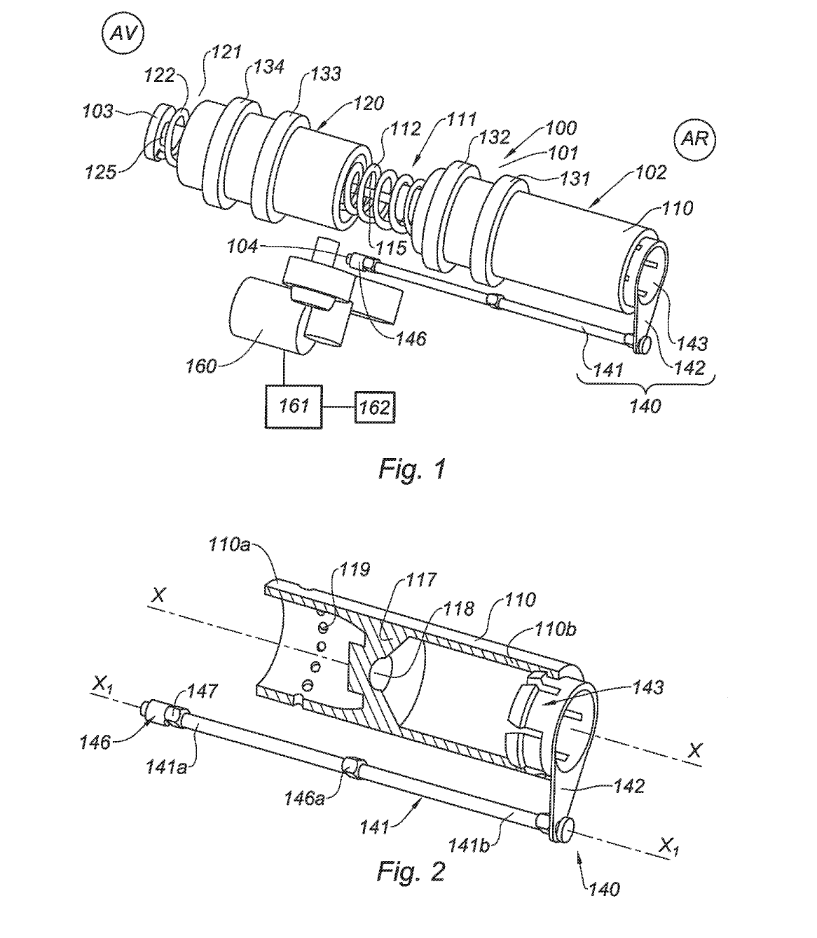

FIG. 1 is a perspective cutaway of an example tandem master cylinder 100 showing, through its housing 101, in borehole 102, primary piston 110 and secondary piston 120, together with their cups (seals) 131-134. Primary piston 110 pushes secondary piston 120. With respect to secondary piston 120, primary piston 110 delimits primary chamber 111 and secondary piston 120 delimits secondary chamber 121 at the end of borehole 102 in the housing of master cylinder 100.

Secondary piston 120 presses against back 103 of secondary chamber 121 through the intermediary of secondary spring 122, and primary piston 110 presses against secondary piston 120 through primary spring 112.

Retainer rod 125 limits the movement of secondary piston 120 against the thrust of secondary spring 122, and another retainer rod 115 limits the extensional movement of primary piston 110 with respect to secondary piston 120 in such a way that the return of the secondary piston and the primary piston to rest position occurs precisely with respect to the brake fluid supply openings when master cylinder 100 is in rest position.

The extension of primary piston 110 when it extends beyond borehole 102 of housing 101 of master cylinder 100 is translationally integral with moving assembly 140, formed by a rod whose rear extremity 141b is connected to a bracket formed by foot 142 of ring 143, integral with the rear of primary piston 110.

The front extremity 141a of rod 141 bears magnet 147. Housing 101 of the master cylinder has drill hole 104 with axis X1X1 parallel to axis XX of borehole 102 of tandem master cylinder 100, and accommodates the end of rod 141 with magnet 147.

Hall sensor 160 is mounted on housing 101 near the rest position of the front extremity 141b of rod 101 with its magnet 147 in order to detect the onset of movement by the rod, that is, the movement of primary piston 110 of tandem master cylinder 100; this corresponds to the detection of braking. Hall sensor 160 is connected to control circuit 161, which activates stoplights 162.

FIG. 2 shows a cutaway of primary piston 110 with moving assembly 140 outside housing 101 of the example tandem master cylinder.

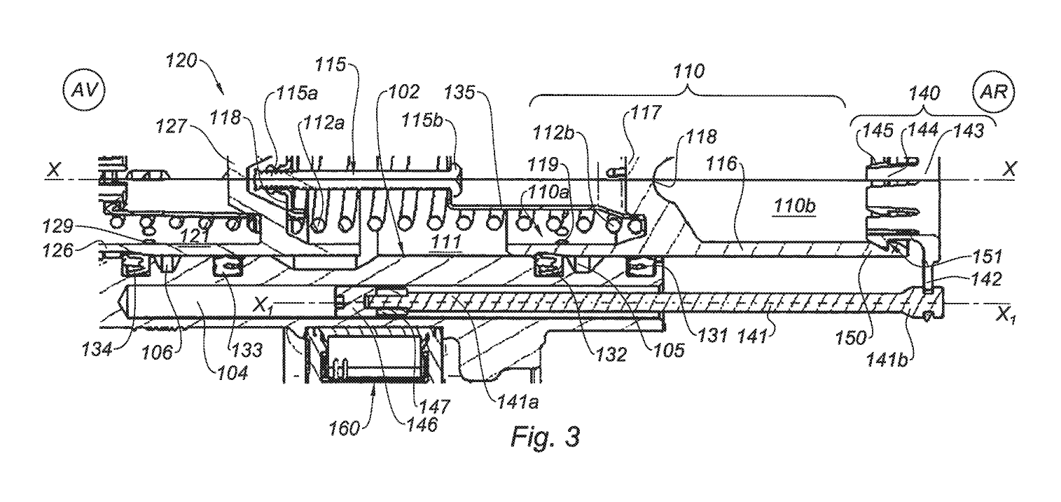

FIG. 2, in combination with the cutaway view of master cylinder 100 of FIG. 3, can be used to better understand the structure of the example tandem master cylinder 100 according to the present invention.

Primary piston 110 consists of cylindrical sleeve 116, subdivided by divider 117 into forward portion 110a and rear portion 110b, each of which is open.

Divider 117 equipped with centering cavity 118 in the rear, accommodates the head of the pushrod actuated by the braking force amplifier; rear extremity 112a of return spring 112, surrounding guide sleeve 135, rests against divider 127 on primary chamber side 111. The bottom of guide sleeve 135 is traversed by rod 115 whose enlarged head 115b is retained behind the forward divider of sleeve 135, its forward extremity 115a being affixed to washer 118 for the support of spring 112 and against which rests divider 127 of secondary piston 120, this having a structure analogous to that of primary piston 110.

Thus, secondary piston 120 is a cylindrical sleeve, 126, subdivided by divider 127, leaving forward part 120b and rear part 120a open, each of them accommodating one end of a return spring (primary spring 112, secondary spring 122).

Primary piston 110 and secondary piston 120, sliding in borehole 102, each have a pierced crown (like crown 119 of primary piston 110 shown in FIG. 2) to supply brake fluid from the brake fluid reservoir and through distribution grooves 105, 106 of the master cylinder housing; grooves 105, 106 are isolated by cup seals 131-134 resting on sleeve 116 of primary piston 110 and sleeve 126 of secondary piston 120 to supply chambers 111, 121 when the tandem master cylinder is in rest position and to then isolate the two chambers, 111, 121 from the reservoir once primary piston 110 begins to be pushed, thereby compressing the brake fluid in primary chamber 111, and thereby pushing secondary piston 120; this isobarically compresses the brake fluid in the primary chamber and in secondary chamber 121, and in the two brake circuits connected to them.

Moving assembly 140, presented in general above, has a bracket formed of ring 143 bearing tongues 144 terminated by hooks 145 of triangular section engaged by plastic deformation of the tongues in the open rear extremity of primary piston 110, the interior of whose cylindrical sleeve 116 is equipped with groove 150 of triangular section, forming hooking edge 151.

Ring 143 bears foot 142, to which is affixed rear extremity 141b of rod 141. Front extremity 141a of rod 141 bears guide piece 146, which retains sleeve-shaped magnet 147 on rod 141.

Rod 141 is engaged in drill hole 104, in which it is guided by part 146. Rod 141 can have intermediary guide piece 146a, as shown in FIG. 2. On the exterior, housing 101 bears Hall sensor 160, and the length of rod 141 is such that at rest (absence of braking action) magnet 147 is opposite sensor 160, which thereby detects its rest position. Once the magnet, displaced by piston 110, leaves its detection position opposite sensor 160, the event is interpreted by operating circuit 161 as the start of braking, triggering stoplights 162.

The connector between ring 143 and primary piston 110 serves as an anchor for transmitting translational movement. This connector can rotate freely so that rod 141 remains aligned on the X1X1 axis of drill hole 104 and so that, even if primary piston 110 pivots around itself, it applies no thrust to rod 141 and there is no risk of it being deflected from its axis X1X1.

The anchoring/clipping of ring 143 by its triangular hooks 145 in groove 150 occurs by means of the rectangular triangular section of hooks 145 whose straight rear side rests against straight edge 151 of the groove; this straight edge is perpendicular to axis XX, which ensures that primary piston 110 precisely pulls rod 141 and its magnet 147 if the brake is activated. The inclines, whose shape is matched to the section of hook 145 and that of groove 150, are inclined toward the front and toward axis XX.

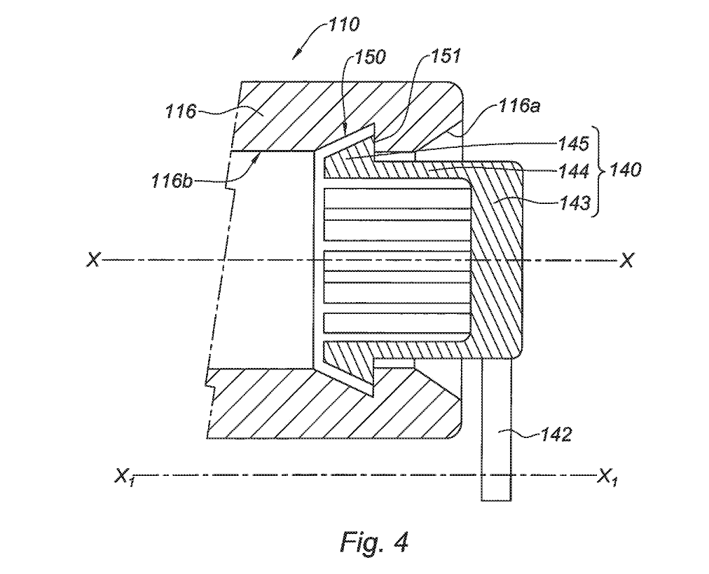

FIG. 4 shows an enlarged detail of moving assembly 240 together with (primary) piston 110. FIG. 4 shows tongues 144 retained or only slightly compressed when hooks 145 are engaged in groove 150, thereby realizing a consistent and final anchorage that resists the back-and-forth movements of primary piston 110.

Nonetheless, this connection is removable for, by compressing the tongues, one can disengage the hooks from the groove and remove the assembly formed by this plug, composed of the ring of tongues equipped with hooks, to replace this part if need be.

The outside diameter of the peaks and hooks of the tongue crown is greater than the diameter of the back 116b of sleeve 116 to produce the effect of clipping bracket 140 in the manner of a bottle cap.

The different elements, 142, 143, 144, 145, of moving assembly 140 are preferably realized of plastic.

What is claimed is:

1. A master cylinder, comprising:
a primary piston controlled by an actuator;
a housing equipped with a borehole accommodating the primary piston, the primary piston extending beyond the borehole, the housing being equipped with a stoplight control and having a drill hole whose axis is parallel to that of the borehole accommodating the primary piston, the drill hole accommodating a magnet whose movement is coupled to that of the primary piston; and
a Hall sensor outside the housing, which detects the movement of the magnet in order to control the stoplights;
wherein the stoplight control includes a moving assembly translationally integral with an end of the primary piston that exits the housing, the stoplight control having a bracket removably affixed to the end of the primary piston, and a rod, whose axis is parallel to the axis of the drill hole, connected to the bracket, an end of the rod being engaged in the drill hole and bearing a magnet to cooperate with the Hall sensor.

2. The master cylinder according to claim 1, wherein the bracket is attached to a rear of the primary piston exiting the housing of the master cylinder by a connector that is free to rotate around the axis of the piston.

3. The master cylinder according to claim 1, wherein the bracket includes a ring having a lateral foot to which is hooked to a head of the rod aligned with the axis of the drill hole.

4. The master cylinder according to claim 3, wherein the bracket includes a hook section in a shape of a rectangular triangle one of whose right-angle rear sides is perpendicular to the axis of the primary piston and its hypotenuse forms an incline descending toward the axis of the primary piston in a forward direction, and a groove of a sleeve of the primary piston having a rectangular triangular section with a straight side perpendicular to the axis of the primary piston and a hypotenuse forming a front of the groove, a second side of a rectangular apex being an open side of the groove.

5. The master cylinder according to claim 1, wherein a rear end of a sleeve of the primary piston has a conical entrance.

6. The master cylinder according to claim 3, wherein the bracket is formed by the ring, tongues equipped with hooks, and the foot, and wherein the bracket and the rod are made of plastic.
